(19) United States
(12) Patent Application Publication
(10) Pub. No.: US 2019/0100235 A1
(43) Pub. Date: Apr. 4, 2019

(54) APPARATUS AND METHOD FOR CONTROLLING VEHICLE STEERING USING LATERAL ACCELERATION

(71) Applicant: MANDO CORPORATION, Pyeongtaek-si (KR)

(72) Inventors: Hyo Gi MIN, Yongin-si (KR); Jong Chun WON, Yongin-si (KR)

(21) Appl. No.: 16/146,226

(22) Filed: Sep. 28, 2018

(30) Foreign Application Priority Data
Sep. 29, 2017 (KR) 10-2017-0126952

(51) Int. Cl. B62D 5/04

(52) U.S. Cl. CPC B62D 5/0472

(57) ABSTRACT

Disclosed are an apparatus and a method for controlling vehicle steering. The apparatus for controlling vehicle steering includes: a reference lateral acceleration extractor configured to extract reference lateral acceleration based on a vehicle speed and a steering angle; a damping application condition determiner configured to determine whether a damping application condition is met based on the reference lateral acceleration and actual lateral acceleration; and a damping current controller configured to, when it is determined that the damping application condition is met, control the damping current applied to an EPS motor.

### CROSS REFERENCE TO RELATED APPLICATION

This application claims priority from Korean Patent Application No. 10-2017-0126952, filed on Sep. 29, 2017, which is hereby incorporated by reference for all purposes as if fully set forth herein.

### BACKGROUND OF THE INVENTION

### 1. Field of the Invention

The present disclosure relates to an apparatus and a method for controlling vehicle steering. More particularly, the present disclosure relates to an apparatus and a method for controlling vehicle steering by extracting reference lateral acceleration according to a vehicle speed and a steering angle and controlling damping current applied to an EPS motor on the basis of the reference lateral acceleration and actual lateral acceleration.

### 2. Description of the Prior Art

For yaw stability of a vehicle, a current EPS receives steering angle information from an angle sensor and applies damping control according to a size of a steering angle and a steering angular speed. “Damping control” means controlling current applied to the EPS motor in order to apply a force to rotate a steering wheel (handle) in the direction opposite the direction in which the steering wheel currently rotates. Damping control is needed in order to improve the yaw stability of the vehicle.

However, the conventional damping control is applied not only to the case in which the steering wheel is returned, that is, the steering angle is returned to the center (0°), but also to the case in which the steering wheel is turned, that is, in which the absolute value of the steering angle increases, and thus some drivers feel damping or friction.

Further, if the damping current is minimized in the damping control in order to solve the problem, when the steering wheel is released after being turned while the vehicle is moving at a high speed, that is, when a driver is not holding the steering wheel, an overshoot problem may occur due to excessive self-aligning torque.

### SUMMARY OF THE INVENTION

Accordingly, in order to solve the problems, reference lateral acceleration according to a vehicle speed and a steering angle may be derived, and damping current applied to an EPS motor may be controlled on the basis of the reference lateral acceleration and actual lateral acceleration in the present disclosure.

In accordance with an aspect of the present disclosure, an apparatus for controlling vehicle steering is provided. The apparatus includes: a reference lateral acceleration extractor configured to extract reference lateral acceleration based on a vehicle speed and a steering angle; a damping application condition determiner configured to determine whether a damping application condition is met based on the reference lateral acceleration and actual lateral acceleration; and a damping current controller configured to, when it is determined that the damping application condition is met, control the damping current applied to an EPS motor.

In accordance with another aspect of the present disclosure, a method of controlling vehicle steering is provided. The method includes: a reference lateral acceleration extraction step of extracting reference lateral acceleration based on a vehicle speed and a steering angle; a damping application condition determination step of determining whether a damping application condition is met on the basis of the reference lateral acceleration and the actual lateral acceleration; and a damping current control step of controlling the damping current applied to an EPS motor when it is determined that the damping application condition is met.

According to the present disclosure, it is possible to minimize overshoot and improve yaw stability of the vehicle by applying a minimum damping current when the steering wheel of the vehicle is turned normally and instantaneously applying a large amount of damping current when the steering wheel of the vehicle is rapidly returned.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates the configuration of an apparatus for controlling vehicle steering according to an embodiment;

FIG. 2 illustrates reference lateral acceleration based on a steering angle according to an embodiment;

FIG. 3 illustrates actual lateral acceleration based on the steering angle when a steering wheel is turned and then returned while the steering wheel is held according to an embodiment;

FIG. 4 illustrates actual lateral acceleration based on the steering angle when the steering wheel is turned and then returned while the steering wheel is released according to an embodiment;

FIG. 5 illustrates an area in which the damping current is applied when the steering wheel is turned and then returned while the steering wheel is released according to an embodiment;

FIG. 6 is a flowchart illustrating a method of controlling vehicle steering according to an embodiment; and

FIG. 7 is a flowchart illustrating a process of controlling the damping current applied to the EPS motor through the vehicle steering control device according to an embodiment.

### DETAILED DESCRIPTION OF THE EXEMPLARY EMBODIMENTS

Hereinafter, embodiments of the present disclosure will be described in detail with reference to the accompanying drawings. In the following description, the same components will be designated by the same reference numerals although they are shown in different drawings. Further, in the following description of the present disclosure, a detailed description of known functions and configurations incorporated herein will be omitted when it is determined that the description may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Lateral acceleration of a vehicle is acceleration applied in the lateral direction of the vehicle. When a driver of the vehicle turns a steering wheel to the left or right, the vehicle performs a rotary motion and thus receives centrifugal force, and the driver in the vehicle feels lateral acceleration. Lateral acceleration has different signs when the lateral acceleration is applied in a rightward direction and a leftward direction. Accordingly, in order to compare the sizes of the lateral acceleration, absolute values of the lateral acceleration should be used.

Hereinafter, the present disclosure will be described in detail with reference to the drawings.

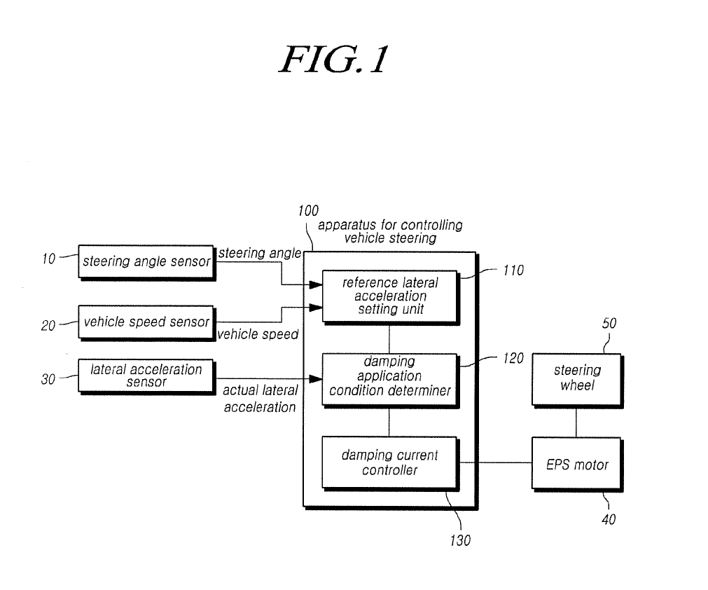

FIG. 1 illustrates the configuration of an apparatus for controlling vehicle steering according to an embodiment.

Referring to FIG. 1, an apparatus 100 for controlling vehicle steering may include a reference lateral acceleration setting unit 110, a damping application condition determination unit 120, and a damping current controller 130.

The reference lateral acceleration setting unit 110 may extract reference lateral acceleration on the basis of a vehicle speed and a steering angle. The reference lateral acceleration setting unit 110 may acquire the value of the current steering angle from a steering angle sensor 10 installed in the vehicle and acquire the value of the current vehicle speed from a vehicle speed sensor 20.

At this time, the reference lateral acceleration is a lateral acceleration value used as a reference for determining how much damping current is applied to an EPS motor 40. The reference lateral acceleration may be determined according to the value of the current vehicle speed and the current steering angle, or may be influenced by other factors.

For example, the reference lateral acceleration setting unit 110 may determine the reference lateral acceleration in proportion to the square of the vehicle speed and the size of the steering angle. The lateral acceleration of the vehicle is proportional to the square of the vehicle speed and inversely proportional to a radius of rotation since the lateral acceleration is basically a value generated by dividing centrifugal force by mass. As the steering angle of the vehicle is larger, the radius of rotation of the vehicle becomes smaller, and as a result, the lateral acceleration of the vehicle also increases. Accordingly, the reference lateral acceleration may be determined to be proportional to the square of the vehicle speed and the size of the steering angle.

In another example, the reference lateral acceleration setting unit 110 may determine that the reference lateral acceleration is proportional to a result value generated by substituting the vehicle speed for a lateral acceleration gain function and proportional to the size of the steering angle. The lateral acceleration of the vehicle may be influenced not only by the vehicle speed and the steering angle but also by other factors. Accordingly, in order to accurately set the reference lateral acceleration, lateral acceleration data according to the vehicle speed and the steering angle may be measured in advance and logged, and the lateral acceleration gain function may be preset on the basis of the logged data.

At this time, the lateral acceleration gain function is a function for deriving a change in the actual lateral acceleration according to the vehicle sped. The lateral acceleration gain function may have the form of a table including a pair of the vehicle speed and the lateral acceleration as well as a preset equation, and may be updated based on experimental values.

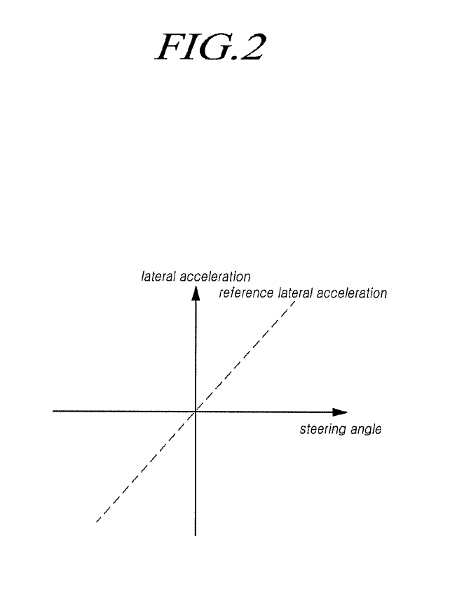

The damping application condition determination unit 120 may determine whether a damping application condition is met on the basis of the reference lateral acceleration extracted by the reference lateral acceleration setting unit 110 and the actual lateral acceleration. The damping application condition determination unit 120 may acquire a value of the actual lateral acceleration from the lateral acceleration sensor 30 installed in the vehicle. The damping application condition determination unit 120 may recognize whether the steering wheel is currently being turned or returned by analyzing the change in the actual lateral acceleration and the difference between the actual lateral acceleration and the reference lateral acceleration, and may recognize whether the driver is holding the steering wheel or the steering wheel has been released. The damping application condition determination unit 120 may identify the damping application condition, that is, determine whether to apply the damping current to the EPS motor on the basis of state information of the steering wheel and the steering angle. Hereinafter, FIGS. 2 to 5 illustrate the damping application condition in detail.

When the damping application condition determination unit 120 determines that the damping application condition is met, the damping current controller 130 may control the damping current applied to the EPS motor. At this time, the damping current generates torque such that the steering wheel approaches the center, that is, a position having a steering angle of 0 degrees. Accordingly, when the steering wheel is returned at a faster angular speed after the steering wheel is turned, the damping current controller 130 is required to reduce the angular speed of the steering wheel by applying higher damping current when the steering wheel approaches the center. Accordingly, the damping current controller 130 may perform control to apply the damping current in proportion to the difference between an absolute value of the actual lateral acceleration and an absolute value of the reference lateral acceleration.

Further, in order to vary the size of the damping current depending on the vehicle speed, steering torque, and the steering angle, the damping current controller 130 may apply weighted values according to the vehicle speed, the steering torque, and the steering angle and perform control to apply the damping current. This makes the damping current most suitable for the vehicle state applied to the EPS motor and thus further improves the yaw stability of the vehicle, and the weighted values may be determined based on actual experimental values.

For example, the damping current controller 130 may perform control to apply the damping current in proportion to the vehicle speed. When the driver suddenly releases the steering wheel and thus the steering wheel is rapidly returned to the center, the steering angle is also rapidly changed. If the change in the steering angle becomes larger while the vehicle speed is fast, movement of the vehicle rapidly increases and the stability of the vehicle may be reduced. Accordingly, in the case in which the vehicle speed is fast, it is required to prevent a rapid steering change when the steering wheel is returned by increasing the applied damping current in proportion to the vehicle speed.

In another example, the damping current controller 130 may perform control to apply the damping current in inverse proportion to the size of the steering torque. The increase in the size of the steering torque may occur when the driver desires to change the vehicle steering according to the corresponding steering torque. If the vehicle steering change is interrupted by the damping current, the time point at which the vehicle steering change intended by the driver is made is delayed, and larger torque should be applied in order to accomplish the steering change intended by the driver. Accordingly, when the size of the steering torque increases, it is required to reduce the applied damping current in inverse proportion to the steering torque.

FIG. 2 illustrates reference lateral acceleration based on the steering angle according to an embodiment.

Referring to FIG. 2, when an x axis is the steering angle and a y axis is the lateral acceleration, a graph of the reference lateral acceleration according to the steering angle (hereinafter, a sign is defined as (+) in rightward steering and (−) in leftward steering) has the form of a straight line marked by the dotted line in FIG. 2. This is because the reference lateral acceleration is proportional to the size of the steering angle. The slope of the straight line may be determined by other factors including the vehicle speed and may be proportional to the result value generated by substituting the square of the vehicle speed or the vehicle speed for the preset lateral acceleration gain function as described above.

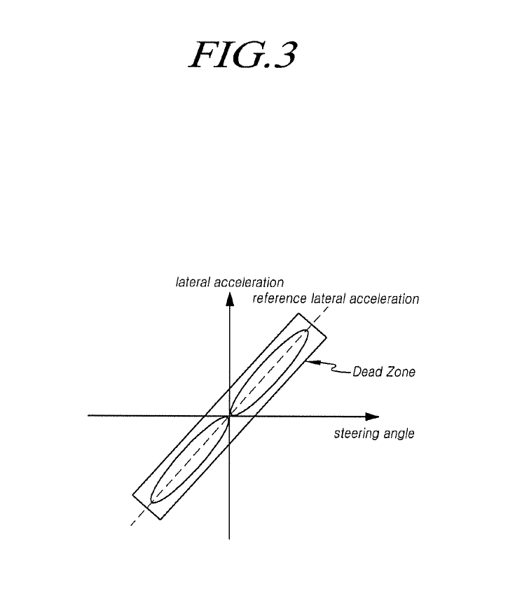

FIG. 3 illustrates actual lateral acceleration based on the steering angle when the steering wheel is turned and then returned while the steering wheel is held according to an embodiment.

Referring to FIG. 3, when the driver of the vehicle turns the steering wheel and then returns the steering wheel while holding the steering wheel, a change in the actual lateral acceleration according to the steering angle has the shape of an oval on the upper right part or the lower left part of FIG. 3. The oval on the upper right part corresponds to a graph showing the change in the lateral acceleration when the steering wheel is returned after being turned to the right and the oval on the lower left part corresponds to a graph showing the change in the lateral acceleration when the steering wheel is returned after being turned to the left.

It can be known that the absolute value of a difference between the reference lateral acceleration and the actual lateral acceleration is equal to or smaller than a particular threshold value on the basis of a comparison of the difference between the actual lateral acceleration and the reference lateral acceleration. That is, the change in the lateral acceleration is made within a dead zone, that is, an area in which the absolute value of the difference between the lateral acceleration and the reference lateral acceleration is smaller than the particular threshold on the graph of FIG. 3. This is because the driver holds the steering wheel and applies a reaction force to the steering wheel to prevent a rapid change in the steering angle while the steering is returned.

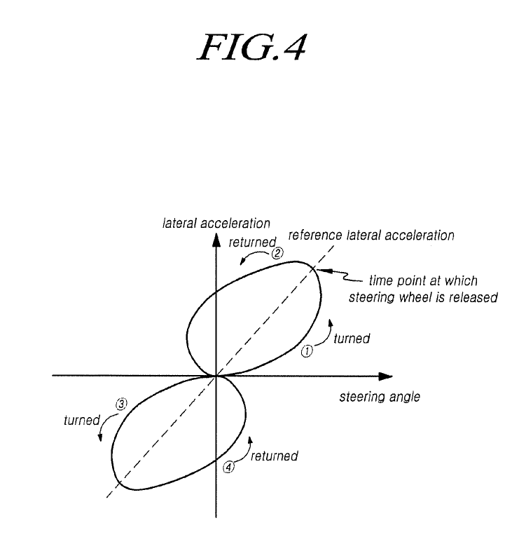

FIG. 4 illustrates actual lateral acceleration based on the steering angle when the steering wheel is turned and then returned while the steering wheel is released according to an embodiment.

Referring to FIG. 4, the size of the steering angle increases when the steering wheel is turned to the right (\textcircled{1}) and the lateral acceleration also increases as the vehicle rotates according to the steering. Thereafter, when the steering wheel is returned (\textcircled{2}), the size of the steering angle is reduced and returned back to 0 degrees.

At this time, the release of the steering wheel means that there is no force that the driver applies to prevent a rapid change in the steering angle, and thus the steering angle rapidly decreases. However, since rotation of the vehicle is conducted with the change in the steering angle, the size of the actual lateral acceleration for the current steering angle becomes larger than the size of the reference lateral acceleration for the current steering angle. Further, since the steering wheel receives a force making the steering angle 0 degrees, the steering angle passes through 0 degrees and receives again the force in the opposite direction, and thus enters a state in which the steering angle is 0 degrees.

Also, when the steering wheel is turned to the left (\textcircled{3}) and then returned (\textcircled{4}), the same phenomenon as the case in which the steering wheel is turned to the right (\textcircled{1}) and then returned (\textcircled{2}) may be generated, with the only difference being that the direction is opposite.

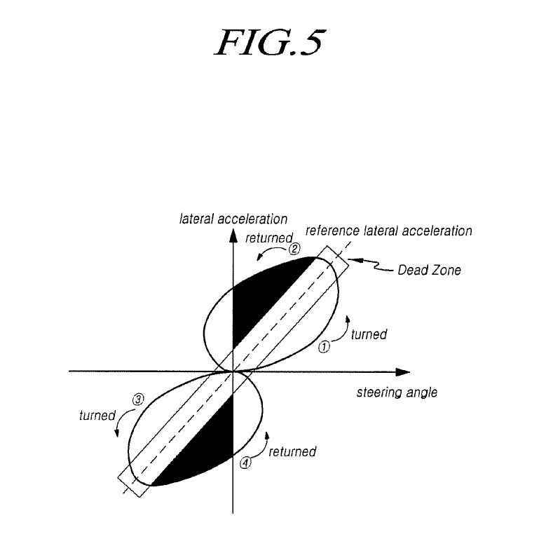

FIG. 5 illustrates an area in which the damping current is applied when the steering wheel is turned and then returned while the steering wheel is released according to an embodiment.

Referring to FIG. 5, the damping current is current applied for a force to rotate the steering wheel in a direction opposite the direction in which the steering wheel is returned in order to increase the yaw stability of the vehicle. Accordingly, if the damping current is applied even when the steering wheel is turned, the driver may feel damping or friction. Therefore, while the steering wheel is turned, that is, when the absolute value of the steering angle increases, the damping current may not be applied.

Further, as illustrated in FIG. 3, in the area in which the absolute value of the difference between the actual lateral acceleration and the reference lateral acceleration is smaller than a particular threshold value, that is, in the dead zone, the driver holds the steering wheel while the steering wheel is returned. In this case, it is determined that the steering wheel is controlled by the user's intention and thus the damping current is not applied.

Further, the damping current is current for applying a force to rotate the steering wheel in a direction opposite the direction in which the steering is returned. Accordingly, applying the damping current after the steering angle of the steering wheel reaches a preset threshold angle (for example, 0 degrees at the center) while the steering wheel is returned rather makes the steering angle of the steering wheel increase in the direction opposite the direction in which the steering angle is returned. Therefore, the damping current is applied only before the steering angle of the steering wheel reaches the preset threshold angle, and from that point on, the damping current should not be applied.

That is, when the steering wheel is being returned in the state in which the steering wheel is released, the damping current may be applied only before the steering wheel reaches the preset threshold angle. Accordingly, black areas on the graph are areas in which the damping current is required to be applied.

Accordingly, when it is determined that the steering wheel is being returned in the state in which the steering wheel is released, the damping application condition determiner 120 of the apparatus 100 for controlling vehicle steering may determine that the damping application condition is met before the size of the steering angle reaches the preset threshold angle. When the damping application condition is met, the damping current controller 130 may perform control to apply the damping current in proportion to the difference between the absolute value of the actual lateral acceleration and the absolute value of the reference lateral acceleration as described above.

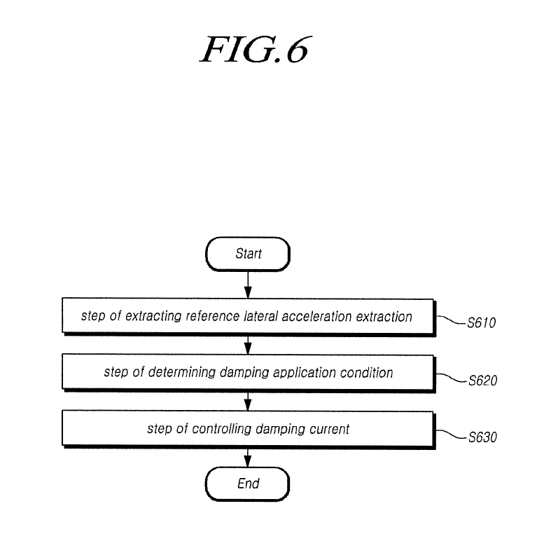

FIG. 6 is a flowchart illustrating a method of controlling vehicle steering according to an embodiment.

Hereinafter, the method performed by the apparatus 100 for controlling vehicle steering described with reference to FIGS. 1 to 5 will be described by way of an example.

Referring to FIG. 6, the method of controlling vehicle steering may include a reference lateral acceleration extraction step of extracting reference lateral acceleration based on a vehicle speed and a steering angle in S610. As described above, the reference lateral acceleration extractor 110 of the apparatus 100 for controlling vehicle steering may set the reference lateral acceleration to be proportional to the square of the vehicle speed and the size of the steering angle. Further, the apparatus 100 for controlling vehicle steering may set the reference lateral acceleration to be proportional to a result value generated by substituting the vehicle speed for a preset lateral acceleration gain function and the size of the steering angle.

Further, the method of controlling vehicle steering may include a damping application condition determination step of determining whether a damping application condition is met on the basis of the reference lateral acceleration and the actual lateral acceleration in S620. As described above, when it is determined that the steering wheel is being returned in the state in which the steering wheel is released, the damping application condition determiner 120 of the apparatus 100 for controlling vehicle steering may determine that the damping application condition is met before the size of the steering angle reaches the size of a preset threshold angle. At this time, when an absolute value of the actual lateral acceleration is larger than an absolute value of the reference lateral acceleration by a preset threshold value or more, the damping application condition determiner 120 may determine that the steering wheel is released.

When it is determined that the damping application condition is met, the method of controlling vehicle steering may include a damping current control step of controlling the damping current applied to an EPS motor in S630. When it is determined that the damping application condition is met, the damping current controller 130 of the apparatus 100 for controlling vehicle steering may control the damping current applied to the EPS motor 40.

As described above, the damping current may be proportional to the difference between the absolute value of the actual lateral acceleration and the absolute value of the reference lateral acceleration, and may be determined with weighted values according to the vehicle speed, steering torque, and steering angle. For example, the damping current may be proportional to the vehicle speed. In another example, the damping current may be inversely proportional to the size of the steering torque.

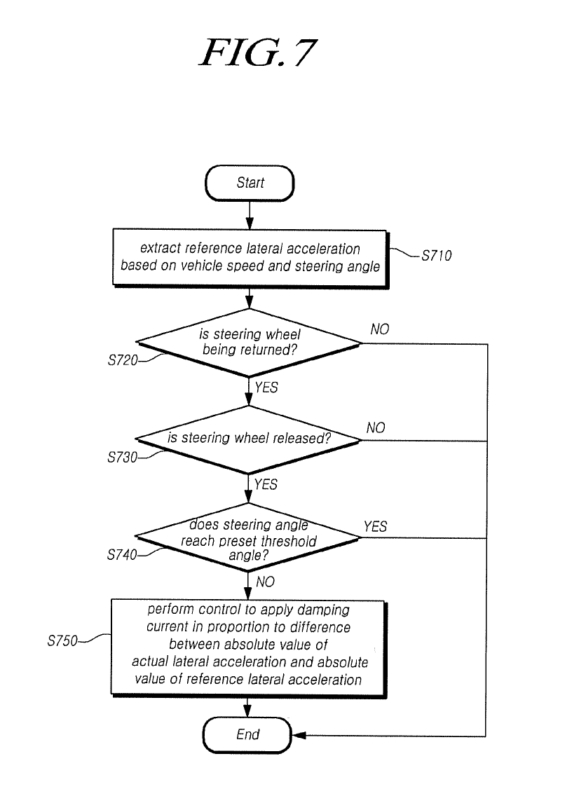

FIG. 7 is a flowchart illustrating a process of controlling the damping current applied to the EPS motor through the apparatus for controlling vehicle steering according to an embodiment.

Hereinafter, the process performed by the apparatus 100 for controlling vehicle steering described with reference to FIGS. 1 to 5 will be described by way of example.

Referring to FIG. 7, the apparatus 100 for controlling vehicle steering may extract reference lateral acceleration based on the steering angle measured by the steering angle sensor 10 and the vehicle speed measured by the vehicle speed sensor 20 in S710. At this time, the extracted reference lateral acceleration may be proportional to the square of the vehicle speed and the size of the steering angle and may also be proportional to the result value generated by substituting the vehicle speed for a preset lateral acceleration gain function and the size of the steering angle as described above with reference to FIG. 1.

The apparatus 100 for controlling vehicle steering may determine whether the damping application condition is met on the basis of the reference lateral acceleration extracted in S710 and the actual lateral acceleration measured by the lateral acceleration sensor 30.

First, the damping application condition determiner 120 of the apparatus 100 for controlling vehicle steering determines whether the steering wheel is returned in S720. As described above, if the damping control is applied when the steering wheel is turned, the driver may feel damping and friction. When the steering wheel is not returned in S720-N, the damping current is not applied to the EPS motor 40.

When it is determined that the steering wheel is returned in S720-Y, the damping application condition determiner 120 of the apparatus 100 for controlling vehicle steering determines whether the steering wheel is released in S730. Whether the steering wheel is released may be determined according to whether the absolute value of the actual lateral acceleration is larger than the absolute value of the reference lateral acceleration by the preset threshold value or more. When the steering wheel is not released in S730-N, the damping current is not applied to the EPS motor 40.

When it is determined that the steering wheel is released in S730-Y, the damping application condition determiner 120 of the apparatus 100 for controlling vehicle steering determines whether the steering angle reaches a preset threshold angle in S740. This is to prevent the increase of the steering angle of the steering wheel in a direction opposite the direction in which the steering wheel is returned, as described with reference to FIG. 5. When the steering angle reaches the preset threshold angle in S740-Y, the damping current is not applied to the EPS motor 40.

Before the steering angle reaches the preset threshold angle in S740-N, the damping current controller 130 of the apparatus 100 for controlling vehicle steering may control the damping current applied to the EPS motor 40 to be proportional to the difference between the absolute value of the actual lateral acceleration and the absolute value of the reference lateral acceleration in S750.

Even if it was described above that all of the components of an embodiment of the present disclosure are coupled as a single unit or coupled to be operated as a single unit, the present disclosure is not necessarily limited to such an embodiment. That is, at least two elements of all structural elements may be selectively joined and operate without departing from the scope of the present disclosure.

Although the embodiments of the present disclosure have been described for illustrative purposes, those skilled in the art will appreciate that various modifications, additions and substitutions are possible, without departing from the scope and spirit of the disclosure. Therefore, the embodiments of the present disclosure are not intended to limit, but are intended to illustrate the technical idea of the present disclosure, and the scope of the technical idea of the present disclosure is not limited by the embodiments. The scope of the present disclosure shall be construed on the basis of the accompanying claims in such a manner that all of the technical ideas included within the scope equivalent to the claims belong to the present disclosure.

What is claimed is:

1. An apparatus for controlling vehicle steering, the apparatus comprising:
a reference lateral acceleration extractor configured to extract a reference lateral acceleration based on a vehicle speed and a steering angle;
a damping application condition determiner configured to determine whether a damping application condition is met based on the reference lateral acceleration and actual lateral acceleration; and
a damping current controller configured to, when it is determined that the damping application condition is met, control a damping current applied to an EPS motor.

2. The apparatus of claim 1, wherein the reference lateral acceleration is proportional to a square of the vehicle speed and a size of the steering angle.

3. The apparatus of claim 1, wherein the reference lateral acceleration is proportional to a result value generated by substituting the vehicle speed for a preset lateral acceleration gain function and is proportional to a size of the steering angle.

4. The apparatus of claim 1, wherein, when it is determined that the steering wheel is being returned in a state in which the steering wheel is released, the damping application condition determiner determines that a damping application condition is met before a size of the steering angle reaches a preset threshold angle.

5. The apparatus of claim 4, wherein, when an absolute value of the actual lateral acceleration is larger than an absolute value of the reference lateral acceleration by a preset threshold speed or more, the damping application condition determiner determines that the steering wheel is released.

6. The apparatus of claim 1, wherein the damping current is proportional to a difference between the absolute value of the actual lateral acceleration and the absolute value of the reference lateral acceleration.

7. The apparatus of claim 1, wherein the damping current is proportional to the vehicle speed.

8. The apparatus of claim 1, wherein the damping current is inversely proportional to a size of a steering torque.

9. A method of controlling vehicle steering, the method comprising:
a reference lateral acceleration extraction step of extracting reference lateral acceleration based on a vehicle speed and a steering angle;
a damping application condition determination step of determining whether a damping application condition is met on the basis of the reference lateral acceleration and actual lateral acceleration; and
a damping current control step of controlling damping current applied to an EPS motor when it is determined that the damping application condition is met.

10. The method of claim 9, wherein the reference lateral acceleration is proportional to a square of the vehicle speed and a size of the steering angle.

11. The method of claim 9, wherein the reference lateral acceleration is proportional to a result value generated by substituting the vehicle speed for a preset lateral acceleration gain function and is proportional to a size of the steering angle.

12. The method of claim 9, wherein the damping application condition determination step comprises, when it is determined that the steering wheel is being returned in a state in which the steering wheel is released, determining that a damping application condition is met before a size of the steering angle reaches a preset threshold angle.

13. The method of claim 12, wherein the damping application condition determination step comprises, when an absolute value of the actual lateral acceleration is larger than an absolute value of the reference lateral acceleration by a preset threshold speed or more, determining that the steering wheel is released.

14. The method of claim 9, wherein the damping current is proportional to a difference between an absolute value of the actual lateral acceleration and an absolute value of the reference lateral acceleration.
